(19) United States
(12) Patent Application Publication
(10) Pub. No.: US 2026/0228140 A1
(43) Pub. Date: Aug. 6, 2026

(54) ENHANCED SYSTEM DETECTION DESIGN OF SOLID-STATE DRIVES (SSD) FOR HOT-PLUG CAPABILITY

(71) Applicant: Micron Technology, Inc., Boise, ID (US)

(72) Inventor: Huayu Chen, Shanghai (CN)

(21) Appl. No.: 19/044,793

(22) Filed: Feb. 4, 2025

(51) Int. Cl. G06F 13/16; G06F 9/4401

(52) U.S. Cl. CPC G06F 13/1668; G06F 9/4401

(57) ABSTRACT

A processing device in a memory system receives, from a host system, a reference clock signal and a reset signal. The processing device determines whether the reference clock signal satisfies a first initialization criterion and the reset signal satisfies a second initialization criterion. Responsive to determining that the reference clock signal and reset bit satisfy the respective initialization criteria, the processing device initializes a data transfer interface with the host system.

### TECHNICAL FIELD

Embodiments of the disclosure relate generally to memory sub-systems, and more specifically, relate to enhanced system detection design of solid-state drives (SSD) for hot-plug capability.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing system that includes a memory sub-system in accordance with some embodiments of the present disclosure.

FIG. 2 is a block diagram illustrating the initialization process of a memory sub-system.

FIG. 3 is a sequence diagram illustrating the initialization of a data transfer interface between a memory sub-system and a host system in accordance with some embodiments of the present disclosure.

FIG. 4 is a flow diagram of an example method to enhance system detection design of solid-state drives (SSD) for hot-plug capability in accordance with some embodiments of the present disclosure.

FIG. 5 is a block diagram of an example computer system in which embodiments of the present disclosure may operate.

### DETAILED DESCRIPTION

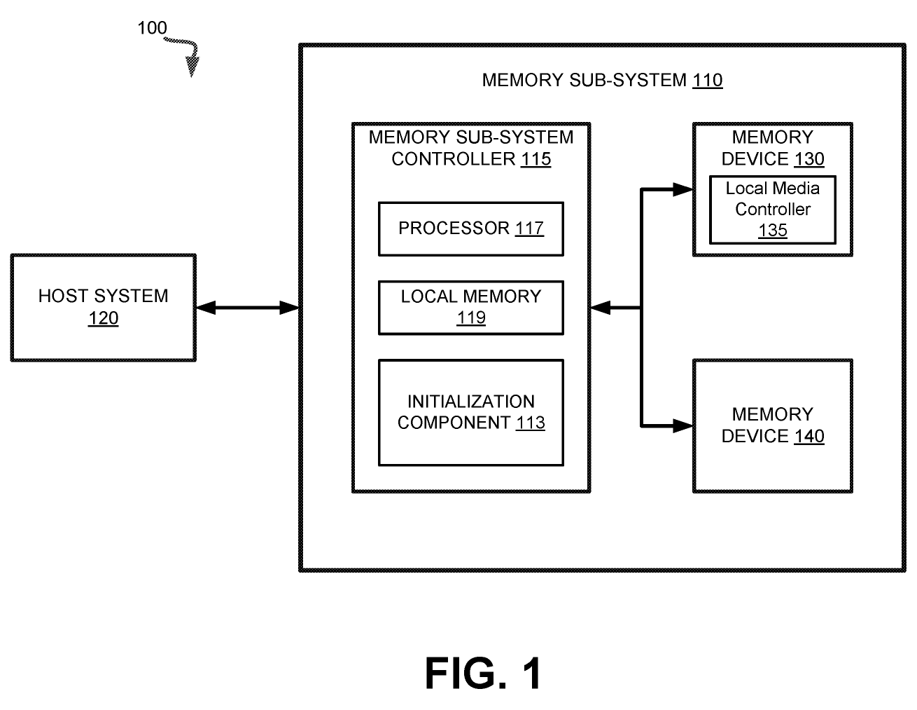

Aspects of the present disclosure are directed to enhanced system detection design of solid-state drives (SSD) for hot-plug capability. A memory sub-system can be a storage device, a memory module, or a combination of a storage device and memory module. Examples of storage devices and memory modules are described below in conjunction with FIG. 1. In general, a host system can utilize a memory sub-system that includes one or more components, such as memory devices that store data. The host system can provide data to be stored at the memory sub-system and can request data to be retrieved from the memory sub-system.

A memory sub-system can include high density non-volatile memory devices where retention of data is desired when no power is supplied to the memory device. One example of non-volatile memory devices is a not-and (NAND) memory device. Other examples of non-volatile memory devices are described below in conjunction with FIG. 1. A non-volatile memory device is a package of one or more dies. Each die can include one or more planes. For some types of non-volatile memory devices (e.g., NAND devices), each plane includes of a set of physical blocks. Each block includes of a set of pages. Each page includes of a set of memory cells ("cells"). A cell is an electronic circuit that stores information. Depending on the cell type, a cell can store one or more bits of binary information, and has various logic states that correlate to the number of bits being stored. The logic states can be represented by binary values, such as “0” and “1”, or combinations of such values.

A memory device (e.g., a memory die) can include memory cells arranged in a two-dimensional or a three-dimensional grid. The memory cells are formed onto a silicon wafer in an array of columns and rows. The memory cells are joined by wordlines, which are conducting lines electrically connected to the control gates of the memory cells, and bitlines, which are conducting lines electrically connected to the drain electrodes of the memory cells. The intersection of a bitline and wordline constitutes the address of the memory cell. A block hereinafter refers to a unit of the memory device used to store data and can include a group of memory cells, a wordline group, a wordline, or individual memory cells. One or more blocks can be grouped together to form separate partitions (e.g., planes) of the memory device in order to allow concurrent operations to take place on each plane. The memory device can include circuitry that performs concurrent memory page accesses of two or more memory planes. For example, the memory device can include multiple access line driver circuits and power circuits that can be shared by the planes of the memory device to facilitate concurrent access of pages of two or more memory planes, including different page types. For ease of description, these circuits can be generally referred to as independent plane driver circuits. Depending on the storage architecture employed, data can be stored across the memory planes (i.e., in stripes). Accordingly, one request to read a segment of data (e.g., corresponding to one or more data addresses), can result in read operations performed on two or more of the memory planes of the memory device.

A host computer system can include memory sub-systems, such as solid-state drives (SSDs), that can be physically removed from the host computer system while the host system is powered on. The host system can detect and establish a connection with the memory sub-systems when the memory sub-systems are connected to the host system and powered on. The connection can be established, e.g., through the Peripheral Component Interconnect express (PCIe) interface. A PCIe interface is a physical and logical connection that facilitates high speed communication between a host system and a PCIe device (e.g., a memory sub-system).

A PCIe interface initialization includes three phases: detection, polling, and configuration. During the detection phase, the host system and the memory sub-system detect each other’s presence through low-frequency signals sent through PCIe lanes, which are data pathways that facilitate communication between the memory sub-system and the host device. In the polling phase, the host system and the memory sub-system can exchange information about their respective capabilities, such as signaling features and reference clock information, thus preparing for link training and configuration. Once the information is exchanged, link training begins. Lastly, during the configuration phase, the host system and memory sub-system exchange information such as layer link width and layer lane numbers. At the end of the configuration phase, a Data Link Layer Link Active (DLLLA) bit is set to indicate that the PCIe link is active and operational for normal data transfer.

If the DLLLA bit fails to be brought to the set state (thus indicating that the PCIe interface was not initialized) within a specified time window (e.g., 1 second) of the memory sub-system being inserted into the host system and powered on, the host system may fail to detect or connect to the memory sub-system. However, completing the PCIe interface initialization may be delayed by the prolonged detection phase, where the host system transmits a detection signal down a detection line. After transmitting the detection signal, the hosts system enters a receive (RX) detection window (e.g., 100 ms) to determine whether the memory sub-system electrically terminates the detection signal within the RX detection window. Electrically terminating the detection signal can involve, e.g., using impedance matching circuits to match the impedance of the detection line. In some implementations, the memory sub-system initializes the PCIe interface after the read-only memory (ROM) and boot loader initialization, which can take up to several hundred milliseconds. If the memory sub-system fails to present the electrical termination within the RX detection window, the memory sub-system will wait, over several milliseconds, until the next RX detection window to present the electrical termination. The delay in completing the detection phase delays the subsequent phases, which may result in the failure to complete the PCIe interface initialization within the specified time window, which in turn may cause the host system to terminate the initialization and disconnect from the memory sub-system, meaning the host system will no longer send or receive data from the memory sub-system.

To address the issue, a memory sub-system can transmit a delay request signal to the host system prior to PCIe initialization, thus informing the host of the impending reset of the PCIe interface, which would cause the host to delay an attempt to detect the memory sub-system and complete the PCIe interface initialization. However, the success of this step is dependent on the behavior of the host system, as not all host systems may be able to reestablish the PCIe link outside of the specified time window.

Aspects of the present disclosure address the above-noted and other deficiencies by the memory sub-systems initializing a data transfer interface link (e.g., PCIe link) with the host system before the memory sub-system initializes the firmware. In one embodiment, when a removeable memory sub-system is connected to a host system and powered on, the memory sub-system controller can receive a reference clock signal and reset signal (e.g., PCIe Express Reset (PERST) signal) from the host system. A controller of the memory sub-system then determines whether the reference clock signal is stable (e.g., the frequency is consistent) and whether the reset signal is de-asserted (e.g., inactive). Should the reference clock signal be stable and the reset signal be de-asserted, the controller can proceed to initialize the data transfer interface before initializing the firmware of the memory sub-system. Initializing the data transfer interface includes a detection phase, the host system transmits a detection signal and enters a RX detection window to detect connected devices. The memory sub-system electrically terminates the detection signal within the RX window (e.g., by matching the impedance of a detection line used to send the detection signal) and is detected by the host system. The earlier data transfer interface initialization increases the likelihood of being detected within an earlier RX detection window. In some embodiments, the controller can maintain an indicator to determine whether the data transfer interface initialization took place before or after the firmware of the memory sub-system is initialized. After the firmware of the memory sub-system has completed initialization, the controller can check the indicator to determine whether the data transfer interface initialization took place. If the data transfer interface initialization took place, then the controller sends a response signal (e.g., transmit (TX) signal) to the host system to begin link training between the host system and memory sub-system.

Advantages of the present disclosure include reducing the delay in the detection phase that would otherwise be caused by entering and booting the firmware of the memory sub-system before initializing the data transfer interface link. The earlier initialization of the data transfer interface link allows the memory sub-system to electrically terminate a detection signal from the host system earlier and be detected within an earlier RX detection window, thus allowing the memory sub-system and host system to complete the detection phase before the firmware of the memory sub-system is initialized. The completed detection phase allows the memory sub-system and host system to enter the polling phase immediately after the firmware of the memory sub-system is initialized. Thus, there is reduced delay because the memory sub-system does not wait for the first available RX detection window after firmware initialization of the memory subsystem, but rather completes the detection phase before the firmware initialization and enters the polling phase after the firmware is initialized. As a result, the memory-sub system and host system can enter the polling and configuration phases of the data transfer initialization earlier due to the lack of delay, which initializes the data transfer interface earlier. The earlier initialization of the data transfer interface increases the likelihood of initializing the data transfer interface within the specific time frame required by the host system, thus reducing the likelihood of the host system terminating the initialization and/or disconnecting from the memory sub-system for failure to initialize the data transfer interface in time.

FIG. 1 illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a combination of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to multiple memory sub-systems 110 of different types. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller, CXL controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a compute express link (CXL) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access components (e.g., memory devices 130) when the memory sub-system 110 is coupled with the host system 120 by the physical host interface (e.g., PCIe or CXL bus). The physical host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include a not-and (NAND) type flash memory and write-in-place memory, such as a three-dimensional cross-point (“3D cross-point”) memory device, which is a cross-point array of non-volatile memory cells. A cross-point array of non-volatile memory cells can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 130 can include one or more arrays of memory cells. One type of memory cell, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 130 can include one or more arrays of memory cells such as SLCs, MLCs, TLCs, QLCs, PLCs or any combination of such. In some embodiments, a particular memory device can include an SLC portion, and an MLC portion, a TLC portion, a QLC portion, or a PLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as a 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), not-or (NOR) flash memory, or electrically erasable programmable read-only memory (EEPROM).

A memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processing device, which includes one or more processors (e.g., processor 117), configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1 has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory devices 130. The memory sub-system controller 115 can be responsible for other operations such as wear leveling operations, garbage collection operations, error detection and error-correcting code (ECC) operations, encryption operations, caching operations, and address translations between a logical address (e.g., a logical block address (LBA), namespace) and a physical address (e.g., physical block address) that are associated with the memory devices 130. The memory sub-system controller 115 can further include host interface circuitry to communicate with the host system 120 via the physical host interface. The host interface circuitry can convert the commands received from the host system into command instructions to access the memory devices 130 as well as convert responses associated with the memory devices 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some embodiments, the memory devices 130 include local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, memory sub-system 110 is a managed memory device, which is a raw memory device 130 having control logic (e.g., local media controller 135) on the die and a controller (e.g., memory sub-system controller 115) for media management within the same memory device package. An example of a managed memory device is a managed NAND (MNAND) device.

The memory sub-system 110 includes a host interface initialization component 113 that can initialize a data transfer interface link (e.g., PCI interface) with a host system before initializing the firmware of the memory sub-system. In some embodiments, the memory sub-system controller 115 includes at least a portion of the initialization component 113. In some embodiments, the initialization component 113 is part of the host system 120, an application, or an operating system. In other embodiments, local media controller 135 includes at least a portion of initialization component 113 and is configured to perform the functionality described herein.

The host interface initialization component 113 can receive, from a host system, a reference clock signal and a reset signal (e.g., PCIe Express Reset (PERST) signal) of the host system. Once the initialization component 113 determines that the reference clock signal is stable (e.g., that the time intervals between consecutive peaks of the reference clock signal differ by no more than a predefined threshold) and that the reset signal is inactive (e.g., de-asserted), the initialization component can initialize a data transfer interface with the host system before initializing the firmware of the memory sub-system. Further details with regards to the operations of the initialization component 113 are described below.

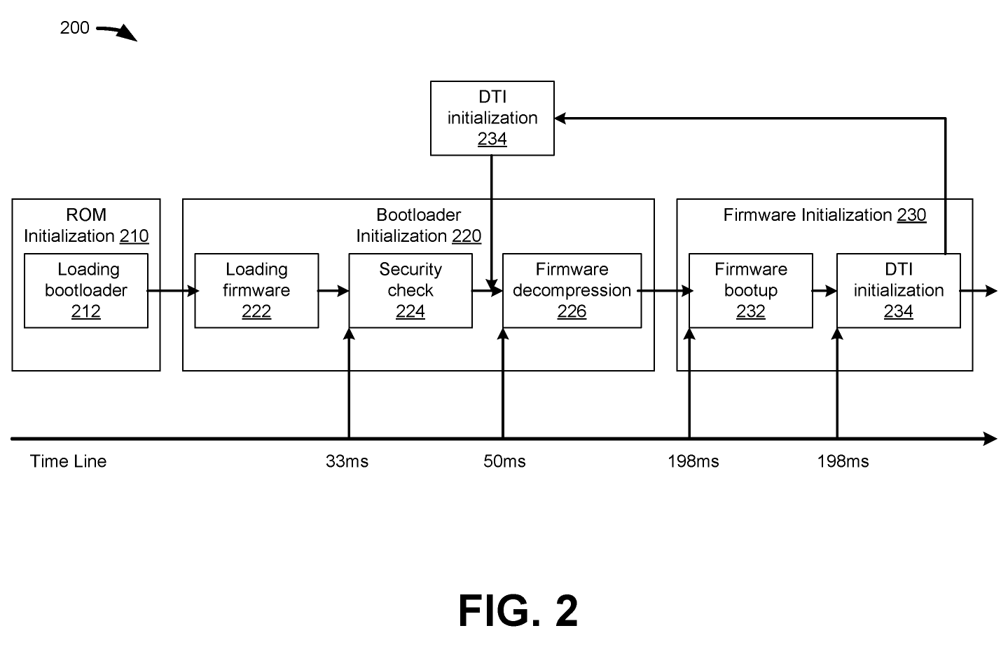

FIG. 2 illustrates a block diagram illustrating the initialization process of a memory sub-system. The block diagram 200 illustrates one embodiment of a memory sub-system 110 initialization process in accordance with aspects of the present disclosure. Processing logic (e.g., host interface initialization component 113) first initializes the read-only memory (ROM) during ROM initialization 210. Processing logic then loads and executes the bootloader code during bootloader initialization 220, as depicted by loading bootloader 212, which may involve loading the firmware of the memory sub-system 222, conducting security checks 224 (e.g., encryption verifications, secure boot mechanisms, etc.), and firmware decompression 226.

In some embodiments, processing logic may receive the reference clock signal and reset signal, which can be asserted by the host system 120 during bootloader initialization 220. The reference clock signal is a periodic signal utilized for synchronizing data transmissions over the data transfer interface. In some embodiments, the reference clock may be a common clock that is shared between the host system 120 and memory sub-system 110. In other embodiments, the host system 120 and memory sub-system 110 maintain separate reference clocks, and the memory sub-system 110 receives the reference clock signal of the host system 120. A reset signal (e.g., a PERST signal) is a control signal asserted by the host system 120 to reset the memory sub-system 110 to ensure that the memory sub-system 110 is properly initialized. For example, if the reset signal is asserted, the memory sub-system 110 stops ongoing processes and resets. If the reset signal is de-asserted, the memory sub-system continues normal initialization and operation.

Processing logic then determines whether the reference clock signal is stable and whether the reset signal is inactive (e.g., de-asserted). A reference clock signal can be considered stable when there is a consistent frequency (e.g., intervals between two consecutive peaks differ by no more than a predefined threshold) and/or when there is minimal drift (e.g., timing errors or deviations from a true or reference time remain below a predefined threshold). For example, the processing logic can check the frequency of the refence clock signal using a frequency detector or counter circuit to determine whether the frequency is consistent and whether there is minimal drift. The de-assert status of a reset signal indicates that the memory sub-system 110 may begin normal operation and continue initializing.

If the reference clock signal is determined to be stable and the reset signal is inactive, then processing logic can perform the data transfer interface (DTI) initialization 234 during bootloader initialization 220 before the firmware decompression 226. Thus, the DTI initialization 234 would take place before the firmware of the memory sub-system 110 is initialized. DTI initialization includes electrically terminating a probe signal (e.g., detection signal) sent by the host system, where processing logic uses resistors to match the impedance of a detection line between the host system 120 and memory sub-system 110 to electrically terminate the probe signal. Depending on the embodiment, the earlier DTI initialization 234 would allow the memory sub-system 110 to electrically terminate the probe signal over 100 ms earlier, increasing the likelihood of being detected by the host system 120 within an RX detection window.

After the firmware decompression 226, processing logic performs firmware bootup 232 in firmware initialization 230, where the firmware of the memory sub-system 110 is initialized and loaded into memory. In some embodiments, processing logic can maintain an indicator (a bit flag) to determine if the DTI initialization 234 has taken place. For example, at the start of bootloader initialization 220, the indicator can be initialized to a value indicative of the DTI initialization not having taken place. If DTI initialization 234 takes place during bootloader initialization 220, then processing logic can change the indicator to a value indicative of the DTI initialization having taken place. After the firmware bootup 232 during firmware initialization 230, processing logic can check the indicator to determine whether DTI initialization 234 has occurred. If DTI initialization 234 has not occurred, then processing logic will perform DTI initialization 234. If DTI initialization 234 has occurred, then processing logic will send a response signal (e.g., transmit (TX) signal) to the host system 120 to enter the polling phase and begin link training.

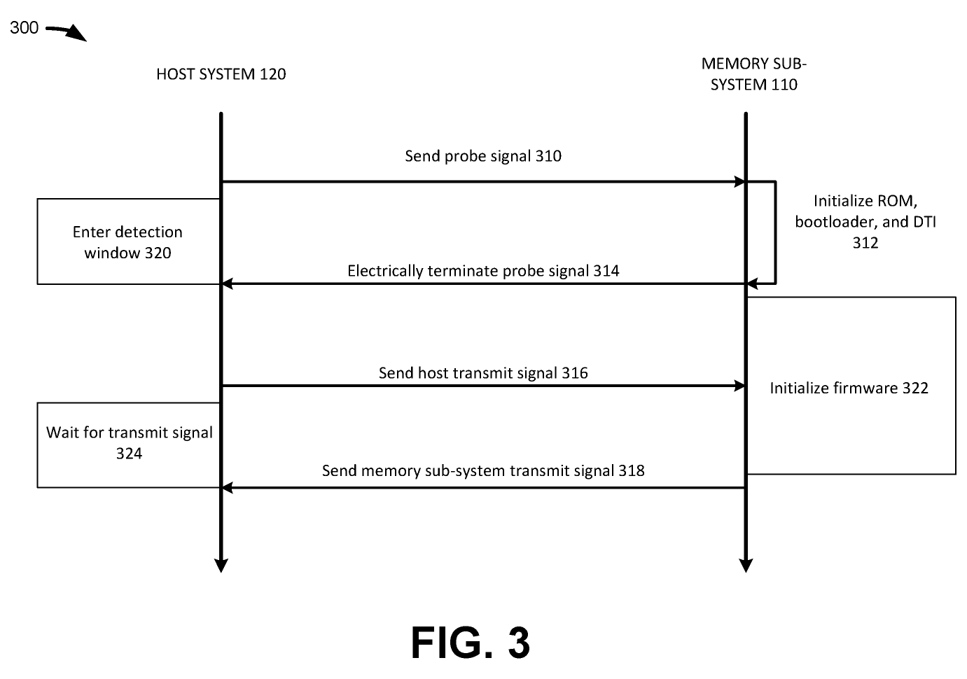

FIG. 3 is a sequence diagram illustrating the initialization of a data transfer interface (DTI) between a memory sub-system and a host system in accordance with some embodiments of the present disclosure. The sequence diagram 300 illustrates one embodiment of the DTI initialization between memory sub-system 110 and host system 120. At operation 310, host system 120 sends a probe signal to the memory sub-system 110. The probe is a test signal to determine whether a memory sub-system (e.g., memory sub-system 110) is present and ready to communicate. After the host system 120 sends the probe signal, it enters a RX detection window at operation 320, where the host system 120 monitors the data transfer lanes (e.g., PCIe lanes) to determine if there is an electrical termination. Electrical termination can include the processing logic utilizing resistors to match the impedance of a transmission line used to send the probe signal, preventing the probe signal from rebounding down the detection line.

At operation 312, processing logic of the memory sub-system 110 (e.g., host interface initialization component) initializes the ROM, bootloader, and the DTI (e.g., PCIe interface). The DTI initialization includes electrically terminating the probe signal sent by the host system, as depicted in operation 314. The RX detection phase is completed when the host system 120 detects the electrical termination. After initializing the DTI, the processing logic begins initializing firmware of the memory sub-system 110, as depicted in operation 322.

At operation 316, the host system 120 sends a TX signal, a type of response signal, to the memory sub-system 110. The TX signal indicates that the host system 120 is ready to proceed with link initialization and begin the polling phase. After sending the TX signal, the host system waits for a TX signal from the memory sub-system at operation 324. The processing logic does not transmit a TX signal in response to the host system 120 until after the firmware of the memory sub-system 110 has completed initialization. Completing firmware initialization of the memory sub-system 110 before transmitting a TX signal ensures that there will not be any errors during the polling phase, as link training uses the firmware components of the memory sub-system 110, such as the DTI controller (e.g., PCIe controller) or internal registers, to communicate with the host system 120. Once the firmware of the memory sub-system 110 is initialized, at operation 318 the processing logic sends a TX signal to the host system 120, entering the polling phase and initiating link training between the host system 120 and the memory sub-system 110.

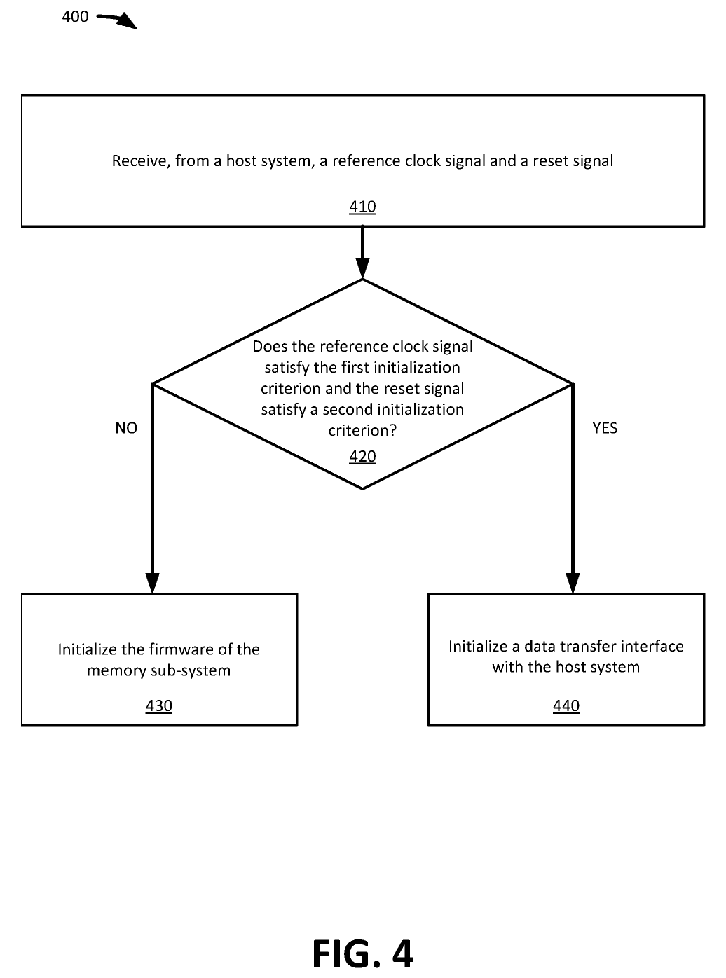

FIG. 4 is a flow diagram of an example method 400 memory sub-system operation to initialize a DTI (e.g., PCIe interface) with a host system, in accordance with some embodiments of the present disclosure. The method 400 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 400 is performed by the host interface initialization component 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 410, the processing logic receives, from a host system 120, a reference clock signal and a reset signal. Both the reference clock signal and reset signal can be transmitted to the memory sub-system 110 via respective lines of the DTI.

In some embodiments, the processing logic can maintain an indicator (a bit flag) indicative of the completion status of the DTI initialization. For example, at operation 410, the processing logic can initialize the indicator to the value indicative of the DTI initialization not having been performed.

At operation 420, the processing logic determines whether the reference clock signal satisfies a first initialization criterion and the reset signal satisfies a second initialization criterion. The first initialization criterion is that the reference clock signal is stable (e.g., the frequency is consistent and/or there is low minimal drift). The second initialization criterion is that the reset signal (e.g., PERST signal) is de-asserted (e.g., inactive). In some embodiments, the processing logic can determine whether the reference clock signal and the reset signal satisfy the respective criterion during the bootloader phase of the memory sub-system initialization.

Responsive to determining that the reference clock signal does not satisfy the first initialization criterion or that the reset signal does not satisfy the second initialization criterion, at operation 430, the processing logic initializes the firmware of the memory sub-system. For example, when the reference clock signal is unstable or the reset signal is asserted, processing logic will initialize the firmware before initializing the DTI.

Responsive to determining that the reference clock signal satisfies the first initialization criterion and that the reset signal satisfies the second initialization criterion, the processing logic initializes a DTI with the host system 120 at operation 440. DTI initialization includes completing a detection phase, where the host system 120 detects the presence of the memory sub-system 110. First, the host system 120 transmits detection probe signals to detect connected devices, such as memory sub-system 110. After transmitting the probe signals, the host system 120 enters a RX detection window, where the host system 120 monitors detection lines used to send the probe signals to detect electrical fluctuations that indicate a connected device. Then, the processing logic electrically terminates the probe signal by using resistors to match the impedance of the detection lines, preventing the probe signal from rebounding down the detection line. The host system 120 detects the electrical termination within the RX detection window and identifies memory sub-system 110 as a connected system. After the DTI initialization, processing logic initializes the firmware of the memory sub-system 110.

In some embodiments, processing logic can check the indicator after the firmware of the memory sub-system 110 is initialized to determine whether the DTI initialization took place. For example, if the indicator indicates that the DTI was not initialized, the processing logic will receive the reference clock signal and reset signal of the host system 120 and initialize the DTI. If the indicator indicates the DTI was initialized, then the processing logic will send a response signal (e.g., TX signal), an electrical signal that carries training and link negotiation information (e.g., information on how many PCIe lanes to use, the data rate, etc.), to the host system 120 to enter the polling phase and begin link training.

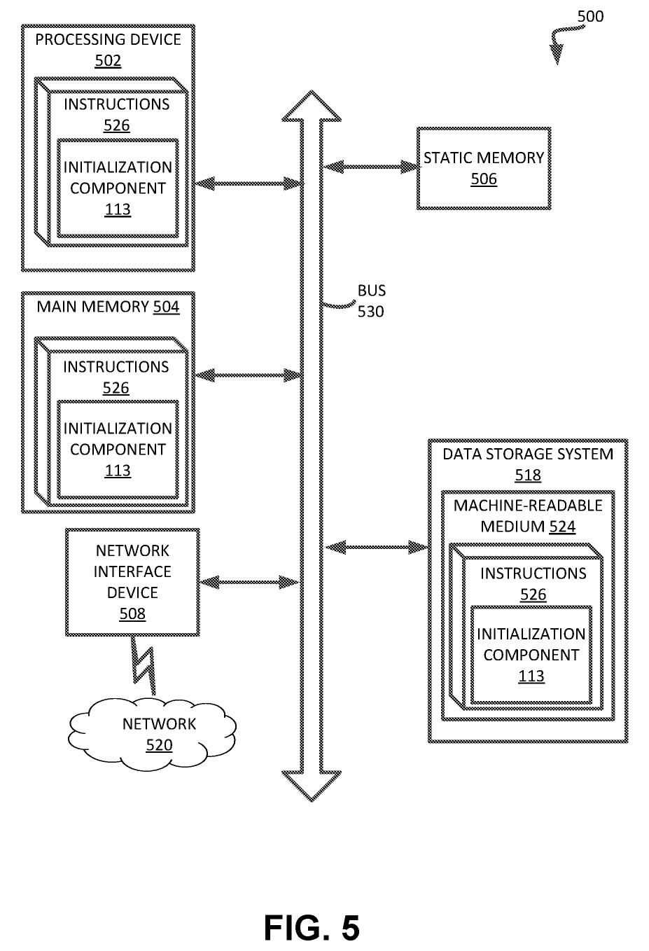

FIG. 5 illustrates an example machine of a computer system 500 within which a set of instructions, for causing the machine to perform any one or more of the methodologies discussed herein, can be executed. In some embodiments, the computer system 500 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the initialization component 113 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 500 includes a processing device 502, a main memory 504 (e.g., read-only memory (ROM), flash memory, dynamic random access memory (DRAM) such as synchronous DRAM (SDRAM) or RDRAM, etc.), a static memory 506 (e.g., flash memory, static random access memory (SRAM), etc.), and a data storage system 518, which communicate with each other via a bus 530.

Processing device 502 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 502 can also be one or more special-purpose processing devices such as an application specific integrated circuit (ASIC), a field programmable gate array (FPGA), a digital signal processor (DSP), network processor, or the like. The processing device 502 is configured to execute instructions 526 for performing the operations and steps discussed herein. The computer system 500 can further include a network interface device 508 to communicate over the network 520.

The data storage system 518 can include a machine-readable storage medium 524 (also known as a computer-readable medium) on which is stored one or more sets of instructions 526 or software embodying any one or more of the methodologies or functions described herein. The instructions 526 can also reside, completely or at least partially, within the main memory 504 and/or within the processing device 502 during execution thereof by the computer system 500, the main memory 504 and the processing device 502 also constituting machine-readable storage media. The machine-readable storage medium 524, data storage system 518, and/or main memory 504 can correspond to the memory sub-system 110 of FIG. 1.

In one embodiment, the instructions 526 include instructions to implement functionality corresponding to a initialization component (e.g., the initialization component 113 of FIG. 1). While the machine-readable storage medium 524 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A system comprising:
a memory device; and
a processing device, operatively coupled to the memory device, to perform operations comprising:
receiving, from a host system, a reference clock signal and a reset signal;
determining whether the reference clock signal satisfies a first initialization criterion and the reset signal satisfies a second initialization criterion; and
responsive to determining that the reference clock signal satisfies the first initialization criterion and the reset signal satisfies the second initialization criterion, initializing a data transfer interface with the host system.

2. The system of claim 1, wherein the operations further comprise:
performing firmware initialization; and
transmitting a response signal to the host system to initiate training one or more link lanes between the memory device and the host system.

3. The system of claim 1, wherein initializing the data transfer interface further comprises performing at least one of: a link training operation, a lane negotiation operation, or an error correction operation.

4. The system of claim 1, wherein determining whether the reference clock signal satisfies the first initialization criterion further comprises:
determining that a frequency of consecutive asserted states of the reference clock signal is stable.

5. The system of claim 1, wherein determining whether the reset signal satisfies the second initialization criterion comprises determining that the reset signal is inactive.

6. The system of claim 1, wherein the operations further comprise:
determining whether the data transfer interface has been initialized; and
responsive to determining that the data transfer interface has been initialized, transmitting a response signal to the host system to initiate training one or more link lanes between the memory device and the host system.

7. The system of claim 6, wherein the operations further comprise:
responsive to determining that an indicator does not indicate that the data transfer interface was initialized before a firmware initialization, initializing the data transfer interface.

8. A method comprising:
receiving, from a host system, a reference clock signal and a reset signal;
determining whether the reference clock signal satisfies a first initialization criterion and the reset signal satisfies a second initialization criterion; and
responsive to determining that the reference clock signal satisfies the first initialization criterion and the reset signal satisfies the second initialization criterion, initializing a data transfer interface with the host system.

9. The method of claim 8, further comprising:
performing a firmware initialization; and
transmitting a response signal to the host system to initiate training one or more link lanes between a memory device and the host system.

10. The method of claim 8, wherein initializing the data transfer interface comprises at least one of: a link training operation, a lane negotiation operation, or an error correction operation.

11. The method of claim 8, wherein determining whether the reference clock signal satisfies the first initialization criterion further comprises:
determining that a frequency of consecutive asserted states of the reference clock signal is stable.

12. The method of claim 8, wherein determining whether the reset signal satisfies the second initialization criterion comprises determining that the reset signal is inactive.

13. The method of claim 8, further comprising:
determining whether the data transfer interface has been initialized; and
responsive to determining that the data transfer interface has been initialized, transmitting a response signal to the host system to initiate training one or more link lanes between a memory device and the host system.

14. The method of claim 13, further comprising:
responsive to determining that an indicator does not indicate that the data transfer interface was initialized before a firmware initialization, initializing the data transfer interface.

15. A non-transitory computer-readable storage medium comprising instructions that, when executed by a processing device, cause the processing device to perform operations comprising:
receiving, from a host system, a reference clock signal and a reset signal;
determining whether the reference clock signal satisfies a first initialization criterion and the reset signal satisfies a second initialization criterion; and
responsive to determining that the reference clock signal satisfies the first initialization criterion and the reset signal satisfies the second initialization criterion, initializing a data transfer interface with the host system.

16. The non-transitory computer-readable storage medium of claim 15, wherein the operations further comprise:
performing a firmware initialization; and
transmitting a response signal to the host system to initiate training one or more link lanes between a memory device and the host system.

17. The non-transitory computer-readable storage medium of claim 15, wherein initializing the data transfer interface comprises at least one of: a link training operation, a lane negotiation operation, or an error correction operation.

18. The non-transitory computer-readable storage medium of claim 15, wherein determining whether the reference clock signal satisfies the first initialization criterion further comprises:
determining that a frequency of consecutive asserted states of the reference clock signal is stable.

19. The non-transitory computer-readable storage medium of claim 15, wherein determining whether the reset signal satisfies the second initialization criterion comprises determining that the reset signal is inactive.

20. The non-transitory computer-readable storage medium of claim 15, wherein the operations further comprise:
determining whether the data transfer interface has been initialized; and
responsive to determining that the data transfer interface has been initialized, transmitting a response signal to the host system to initiate training one or more link lanes between a memory device and the host system.
